(19) United States
(12) Patent Application Publication
(10) Pub. No.: US 2026/0120062 A1
(43) Pub. Date: Apr. 30, 2026

(54) SYSTEMS AND METHODS FOR INSPECTING AND REPAIRING AN AUTOMATED VEHICLE

(71) Applicant: Ford Global Technologies, LLC, Dearborn, MI (US)

(72) Inventors: Brendan Diamond, Naples, FL (US); Stuart C. Salter, White Lake, MI (US); Krishna Bandi, Novi, MI (US); Vyas Darshan Shenoy, Canton, MI (US); Mario Anthony Santillo, Canton, MI (US); Keith Weston, Canton, MI (US)

(73) Assignee: Ford Global Technologies, LLC, Dearborn, MI (US)

(21) Appl. No.: 18/927,540

(22) Filed: Oct. 25, 2024

(51) Int. Cl. G06Q 10/20; B60W 30/06; G07C 5/00

(52) U.S. Cl. CPC G06Q 10/20; B60W 30/06; G07C 5/006; G07C 5/008; B60W 2556/45

(57) ABSTRACT

A method includes the generation of a service-based list associated with a vehicle, a determination of one or more service-based operations, a transmission to a management system of a service request, a receipt of one or more instructions indicative of a location of a parking zone based on a complexity rating associated with each operation of the one or more service-based operations, and movement of the vehicle to the parking zone in response to receiving the one or more instructions.

### FIELD

The present disclosure relates to an inspection of a vehicle and performing one or more repairs to the vehicle based on the inspection. More specifically, the present disclosure relates to the automation of the inspection and the performance of the one or more repairs.

### BACKGROUND

The statements in this section merely provide background information related to the present disclosure and may not constitute prior art.

Inspection and associated repairs of a vehicle can be time-consuming during a manufacturing process of the vehicle. Inefficiencies of performing the inspection and associated repairs may result from an inability to determine or track availability of a repair bay or what types of repairs the repair bay may be equipped to accommodate based on available tools and/or resources. An inability to prioritize the repairs and/or inspections also may result in inefficiencies as the repairs and/or inspections cannot be completed in a timely manner. The present disclosure addresses these and other issues related to the inspection and repair of one or more vehicles as part of an automated inspection and repair system.

### SUMMARY

This section provides a general summary of the disclosure and is not a comprehensive disclosure of its full scope or all of its features.

The present disclosure provides a method comprising: generating a service-based list associated with a vehicle; determining one or more service-based operations based on the service-based list; transmitting, to a management system, a service request that includes information associated with each operation of the one or more service-based operations; receiving, from the management system, one or more instructions indicative of a location of a parking zone based on a complexity rating associated with each operation of the one or more service-based operations; and moving the vehicle to the parking zone in response to receiving the one or more instructions; wherein the generation of the service-based list is based on an observation made by an operator, an inspection of the vehicle by an infrastructure system, self-identification of one or more issues associated with the vehicle, or a combination thereof; further comprising: prioritizing one or more service-based tasks included as part of the service-based list based on an association of each task of the one or more service-based tasks with a functionality of one or more components of the vehicle; wherein the information associated with each operation of the one or more service-based operations relates to one or more tools, one or more resources, or a combination thereof; wherein the one or more tools and the one or more resources includes a vehicle lift, a fluid removal system, a fill system, diagnostic equipment, a component-specific lift, sensor calibration equipment, or a combination thereof; wherein the one or more instructions directs the vehicle to a short-term storage location of the parking zone based on a low complexity rating associated with the service request; and wherein the one or more instructions directs the vehicle to a location of the parking zone proximate a workstation equipped to perform a service based on a high complexity rating associated with the service request and the one or more service-based operations.

The present disclosure provides another method comprising: receiving, from a vehicle, a service request that includes information associated with each operation of one or more service-based operations, wherein the information relates to one or more tools, one or more resources, or a combination thereof; determining a complexity rating associated with each operation of the one or more service-based operations; transmitting, to the vehicle, one or more instructions indicative of a location of a parking zone based on the determination of the complexity rating associated with each operation of the one or more service-based operations; and causing the vehicle to move to the parking zone; wherein one or more service-based tasks included as part of a service-based list is prioritized based on an association of each task of the one or more service-based tasks with a functionality of one or more components of the vehicle, and wherein the one or more service-based operations is based on the service-based list; wherein the one or more instructions directs the vehicle to a short-term storage location of the parking zone based on a low complexity rating associated with the service request; wherein the one or more instructions directs the vehicle to a location of the parking zone proximate a workstation equipped to perform a service based on a high complexity rating associated with the service request and the one or more service-based operations; further comprising: determining that the workstation is equipped to perform the service based on an availability of the workstation and whether the one or more tools and the one or more resources matches one or more tools of the workstation and one or more resources of the workstation; and further comprising: assigning the vehicle a position in a service-based queue based on the complexity rating.

The present disclosure provides a system comprising: a management system configured to: receive, from a vehicle, a service request that includes information associated with each operation of one or more service-based operations, wherein the information relates to one or more tools, one or more resources, or a combination thereof, determine a complexity rating associated with each operation of the one or more service-based operations, transmit, to the vehicle, one or more instructions indicative of a location of a parking zone based on the determination of the complexity rating associated with each operation of the one or more service-based operations; and the vehicle configured to: generate a service-based list associated with the vehicle, determine one or more service-based operations based on the service-based list, transmit, to the management system, the service request, and receive the one or more instructions, wherein in response to receiving the one or more instructions the vehicle is configured to move to the parking zone; wherein the generation of the service-based list is based on an observation made by an operator, an inspection of the vehicle by an infrastructure system, self-identification of one or more issues associated with the vehicle, or a combination thereof; wherein the vehicle is further configured to: prioritize one or more service-based tasks included as part of the service-based list based on an association of each task with the one or more service-based tasks to a functionality of one or more components of the vehicle; wherein the one or more instructions directs the vehicle to a short-term storage location of the parking zone based on a low complexity rating associated with the service request; wherein the one or more instructions directs the vehicle to a location of the parking zone proximate a workstation equipped to perform a service based on a high complexity rating associated with the service request and the one or more service-based operations; wherein the management system is further configured to: determine that the workstation is equipped to perform the service based on an availability of the workstation and whether the one or more tools and the one or more resources matches one or more tools of the workstation and one or more resources of the workstation; and wherein the management system is further configured to: assign the vehicle a position in a service-based queue based on the complexity rating.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates a system for automated vehicle marshaling in accordance with one or more embodiments of the present disclosure;

FIG. 2 illustrates an example vehicle marshaled by the system shown in FIG. 1 in accordance with one or more embodiments of the present disclosure;

FIG. 3 illustrates an example marshaling environment in accordance with one or more embodiments of the present disclosure;

FIG. 4 is a flowchart illustrating an example method for inspecting and repairing a vehicle in accordance with one or more embodiments of the present disclosure;

FIG. 5 is a flowchart illustrating another example method for inspecting and repairing a vehicle in accordance with one or more embodiments of the present disclosure; and

FIG. 6 is a block diagram illustrating an example computer system in accordance with one or more embodiments of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

One or more examples provides a means for vehicle-based inspection and/or repairs during a manufacturing process, as well as management of fulfilling a subsequent inspection and/or repair. In one or more embodiments, the inspection and associated repair(s) of the vehicle is fully automated and initiated by the vehicle itself, which provides an advantage over manufacturing processes that require a human operator to conduct the initial inspection instead of the vehicle. This is especially advantageous in an instance where a large volume of vehicles is being manufactured and provides a time-saving solution to inspections otherwise made by a human operator.

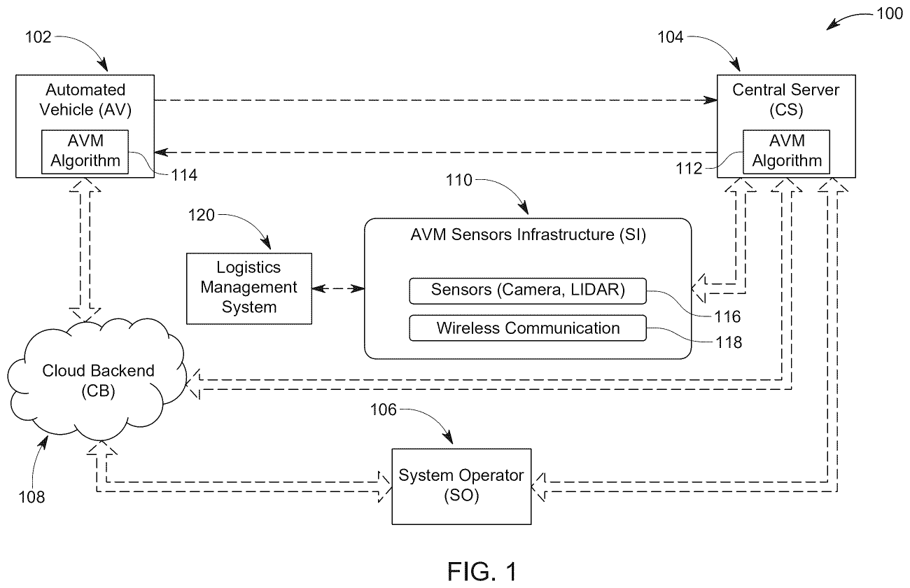

FIG. 1 shows a schematic block diagram illustrative of an automated vehicle marshaling (AVM) system 100. In one or more examples, the AVM system 100 marshals one or more vehicles (e.g., a vehicle 102) traveling at a low speed. However, it is understood that the AVM system 100 may marshal the one or more vehicles traveling at any speed. It is also understood that the AVM system 100 may marshal semi-autonomous vehicles and/or fully autonomous vehicles.

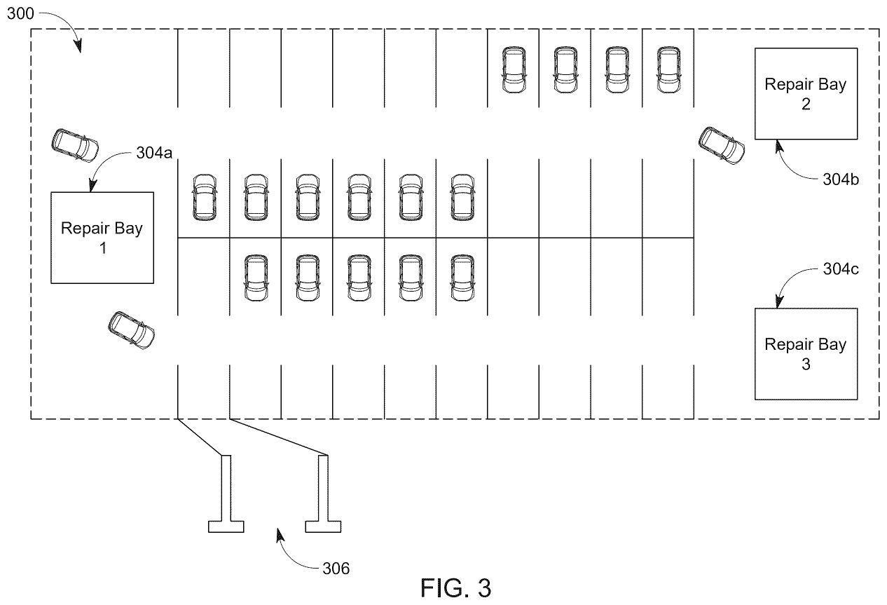

The AVM system 100 generally includes the vehicle 102, a central server 104, a system operator 106, a cloud system 108, and an infrastructure system 110. The central server 104 operates as a central point of communication related to the AVM system 100 and manages and/or facilitates any manufacturing process associated with the vehicle 102. For example, the central server 104 facilitates marshaling of the one or more vehicles, which causes the one or more vehicles to travel through (e.g., traverse) a marshaling environment (e.g., a marshaling environment 300 as shown in FIG. 3). In one or more examples, the marshaling environment 300 can be, but is not limited to, a factory floor or parking lot.

The central server 104 is configured to wirelessly communicate directly with each of the components of the AVM system 100 (e.g., the vehicle 102, the system operator 106, the cloud system 108, and the infrastructure system 110) and can include an infrastructure-side AVM algorithm 112. The central server 104 is also configured to provide logical interface information received from the infrastructure system 110 to the vehicle 102. Additionally, the central server 104 is configured to calculate one or more maneuvers (e.g., movements) associated with the vehicle 102.

The infrastructure-side AVM algorithm 112 processes status information associated with at least the vehicle 102 of the one or more vehicles. It is understood that the infrastructure-side AVM algorithm 112 also processes status information associated with each vehicle of the one or more vehicles. The central server 104 is configured to utilize the infrastructure-side AVM algorithm 112 to transmit one or more instructions and/or process information received from each of the components of the AVM system 100 (e.g., the vehicle 102, the system operator 106, the cloud system 108, and the infrastructure system 110). For example, the received information can be related to, but is not limited to, marshaling the vehicle 102 and/or visual based communication with the vehicle 102.

Particularly, based on the direct communication with the one or more vehicles, the central server 104 is further configured to cause the one or more vehicles to start, stop (e.g., at a particular parking location), or pause progression through the marshaling environment 300. The central server 104 is further configured to control a marshaling speed of the one or more vehicles as the one or more vehicles travel through the marshaling environment 300.

The vehicle 102 includes a vehicle-side AVM algorithm 114. In one or more embodiments, the vehicle 102 utilizes the vehicle-side AVM algorithm 114 to process and send information gathered by one or more components associated with the construct of the vehicle 102, such as a component internally and/or externally disposed related to the vehicle 102. For example, although not shown, the components associated with the construct of the vehicle 102 can include a wireless transmission module, a vehicle central gateway module, a vehicle infotainment system, one or more vehicle sensors, a vehicle battery, a vehicle global navigation satellite (e.g., GNSS), a vehicle navigation mapping system, and/or a controller area network (CAN) vehicle bus. It is understood that marshaling of the vehicle 102 within the AVM system 100 can be supported by the utilization of any of the one or more components associated with the construct of the vehicle 102.

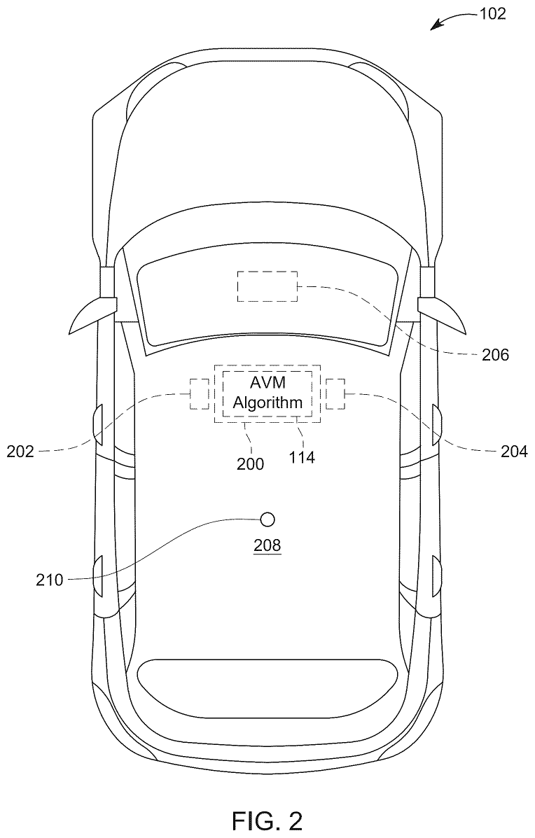

More particularly, and with reference to FIG. 2, in various forms, the vehicle(s) 102 may be powered in a variety of ways, for example, with an electric motor and/or an internal combustion engine. It is understood that the vehicle(s) 102 may be any type of vehicle powered by an electric motor and/or an internal combustion engine such as a car, a truck, a robot, a plane, and/or a boat. The vehicle(s) 102 generally include the vehicle controller 200, one or more actuators 202, a plurality of on-board sensors 204, a human machine interface (HMI) 206, and a vehicle system 208. The vehicle(s) 102 also has a reference point 210, that is, a specified point within a space defined by a vehicle body that identifies the location of the vehicle(s) 102. For example, the reference point 210 is a geometrical center point at which respective longitudinal and lateral center axes of the vehicle(s) 102 intersects. As another example, the reference point 210 is a point at which the vehicle(s) 102 is located as the vehicle(s) 102 navigates toward a waypoint, such as to park the vehicle 102.

The vehicle controller 200, in some examples, is configured or programmed to control the operation of one or more of vehicle brakes, propulsion (e.g., control of acceleration in the vehicle(s) 102 by controlling one or more of an internal combustion engine, electric motor, hybrid engine, etc.), steering, climate control, interior and/or exterior lights, etc. The vehicle controller 200, in other examples, is further configured or programed to determine whether and when the vehicle controller 200, as opposed to a human operator, is to control such operations related to the vehicle(s) 102. It is understood that any of the operations associated with the vehicle(s) 102 may be facilitated via an automated, a semi-automated, or a manual mode. For example, the automated mode may facilitate any of the operations to be fully controlled by the vehicle controller 200 without the aid of the human operator. As another example, the semi-automated mode may facilitate any of the operations to be at least partially controlled by the human operator in combination with the vehicle controller 200. As a further example, the manual mode may facilitate the operations to be fully controlled by the human operator without the aid of the vehicle controller 200.

The vehicle controller 200 includes, or may be communicatively coupled to (e.g., via a vehicle communications bus), one or more processors (not shown). For example, the one or more processors can be a controller, or the like, included in the vehicle(s) 102 for monitoring and/or controlling various vehicle controllers, such as a powertrain controller, a brake controller, a steering controller, etc. The vehicle controller 200 is generally arranged for communications on a vehicle communication network (not shown) that can include a bus in the vehicle(s) 102 such as a CAN bus, or the like, and/or other wired and/or wireless mechanisms.

Via a vehicle network, the vehicle controller 200 transmits messages to various devices in the vehicle(s) 102 and/or receives messages from the various devices, for example, the one or more actuators 202, the HMI 206, etc. Alternatively, or additionally, in cases where the vehicle controller 200 includes multiple devices, the vehicle communication network is utilized for communications between devices represented as the vehicle controller 200 in this disclosure. Further, as discussed below, various other controllers and/or sensors provide data to the vehicle controller 200 via the vehicle communication network.

In addition, the vehicle controller 200, via the vehicle-side AVM algorithm 114, is configured for communicating through a vehicle-to-infrastructure communication network, such as communicating with an infrastructure controller (not shown). The vehicle controller 200, via the vehicle-side AVM algorithm 114, is also configured for communicating through a wireless vehicular communication interface with other traffic objects (e.g., vehicles, infrastructures, etc.), such as, via a vehicle-to-vehicle communication network. The vehicular communication network represents one or more mechanisms by which the vehicle controller 200 of the vehicle(s) 102 communicates with other traffic objects. As an example, the vehicular communication network may be one or more of wireless communication mechanisms, including any desired combination of wireless (e.g., cellular, wireless, satellite, microwave, and/or radio frequency) communication mechanisms and any desired network topology (or topologies when multiple communication mechanisms are utilized). Examples of vehicular communication networks include, among others, cellular, Bluetooth@, IEEE 802.11, dedicated short range communications (DSRC), and/or wide area networks (WAN), including the Internet, providing data communication services.

The one or more actuators 202 are implemented via circuits, chips, or other electronic and/or mechanical components that can actuate various vehicle subsystems in accordance with appropriate control signals. The one or more actuators 202 may be used to control braking, acceleration, and/or steering of the vehicle(s) 102. The vehicle controller 200 can be programmed to activate the one or more actuators 202 including propulsion, steering, and/or braking based on the planned acceleration or deceleration of the vehicle(s) 102.

The plurality of on-board sensors 204 include a variety of devices to provide data to the vehicle controller 200. For example, the plurality of on-board sensors 204 may include object detection sensors (e.g., lidar sensor(s)) disposed on or in the vehicle(s) 102 that provide relative locations, sizes, and/or shapes of one or more objects surrounding the vehicle(s) 102, such as additional vehicles, bicycles, robots, drones, etc., travelling next to, ahead, and/or behind the vehicle(s) 102. As another example, one or more of the plurality of on-board sensors 204 can be radar sensors affixed to one or more bumpers of the vehicle(s) 102 that may provide locations of the object(s) relative to the location of each of the vehicles 102.

The plurality of on-board sensors 204 may include a camera sensor, for example, to provide a front view, side view, rear view, etc., providing images from an area surrounding the vehicle(s) 102. As another example, the vehicle controller 200 may be programmed to receive sensor data from a camera sensor(s) and to implement image processing techniques to detect a road, infrastructure elements, etc. The vehicle controller 200 may be further programmed to determine a current vehicle location based on location coordinates (e.g., GPS coordinates) received from the vehicle(s) 102 indicative of a location of the vehicle 102 determined from a GPS sensor (not shown).

The HMI 206 is configured to receive information from the human operator during operation of the vehicle(s) 102. Moreover, the HMI 206 is configured to present information to the human operator, such as, an occupant of the vehicle(s) 102. In some variations, the vehicle controller 200 is programmed to receive destination data (e.g., location coordinates) from the HMI 206.

The vehicle system 208 is configured to control each of the subsystems within the vehicle(s) 102 and facilitate requests across each of the above-described components (e.g., the vehicle controller 200, the one or more actuators 202, the plurality of on-board sensors 204, and/or the HMI 206). Accordingly, the vehicle(s) 102 can be autonomously guided toward a waypoint using at least the plurality of on-board sensors 204. Routing can be performed using vehicle location, distance to travel, queue in line for vehicle marshaling, etc.

Referring back to FIG. 1, and in one or more embodiments, in addition to or in alternative to the infrastructure system 110, the vehicle-side AVM algorithm 114 may determine the status information associated with the vehicle 102 based on processed information as is further described herein. In another one or more embodiments, the vehicle 102 utilizes the vehicle-side AVM algorithm 114 to process and send information obtained from any of the components associated with the construct of the vehicle 102 to the central server 104, and/or the cloud system 108. However, it is understood that the vehicle 102 can utilize the vehicle-side AVM algorithm 114 to process and send information obtained from any of the components associated with the construct of the vehicle 102 directly to the infrastructure system 110 and/or the system operator 106. Additionally, the vehicle-side AVM algorithm 114 is further configured to process and send information received from any of the components of the AVM system 100 to any of the components associated with the construct of the vehicle 102.

The central server 104 is configured to cause the infrastructure system 110 to monitor the progression of the one or more vehicles as the vehicle(s) move through the marshaling environment 300. The infrastructure system 110 includes a sensor component 116 and a wireless communication component 118. For example, the wireless communication component 118 may utilize GPS, Wi-Fi, satellite, 3G/4G/5G, and/or Bluetooth™ to communicate with the one or more vehicles. It is understood that by utilizing either of the sensor component 116 and/or the wireless communication component 118, the infrastructure system 110 is configured to perform localization function(s) associated with the marshaling of the vehicle 102, such as, but not limited to, perception, path-planning, detection, controls, response of the vehicle 102, or a combination thereof, among others.

The wireless communication component 118 communicates with the sensor component 116 that is configured to manage, for example, one or more of cameras, lidar, radar, and/or ultrasonic devices. The sensor component 116 monitors the movement of the one or more vehicles as the one or more vehicles are marshaled through the marshaling environment 300.

The system operator 106 can be a human operator tasked with monitoring the marshaled one or more vehicles by communicating with the cloud system 108. It is understood that the cloud system 108 is a backend system that may represent an original equipment manufacturer cloud system responsible for remote engagement and/or disengagement of AVM application(s) including enrollment and/or unenrollment of the vehicle 102 from the AVM system 100. In one or more embodiments, the system operator 106 communicates with the cloud system 108 and/or monitors the one or more vehicles via a user device (not shown) and/or a human eye of the human operator. However, it is understood that the system operator 106 can also be a non-human operator, such as a mainframe controller, a machine-learning based control system, or any neural network. It is also understood that the system operator 106 is tasked with managing and/or supervising operation of the vehicle 102 (e.g., via an in-facility interface) during automated marshaling, an onboarding process, and/or at individual locations. The system operator 106 is able to receive instructions from the central server 104 and forward those instructions on to the one or more vehicles, via the cloud system 108. For example, the instructions received from the central server 104 can be one or more marshaling commands that can cause the one or more vehicles to travel to a vehicle repair bay, a parking location, a future location, or any other location.

In one or more embodiments, the system operator 106 can obtain information associated with the operation of the vehicle 102. In one or more embodiments, the obtained information can be displayed on the user device based on one or more determinations made by a logistics management system 120 regarding an inspection and/or any recommended repairs associated with the vehicle 102 within the marshaling environment 300. For example, the user device can be a tablet or any other suitable electronic device. As another example, the one or more determinations are made by utilizing at least the sensor component 116 of the infrastructure system 110 and/or the plurality of on-board sensors 204. In another one or more embodiments, the infrastructure system 110 is configured to communicate (e.g., via a wireless or a wired means) with the logistics management system 120. While the logistics management system 120 is depicted as externally disposed from the infrastructure system 110, it is understood that the logistics management system 120 can be internally disposed within the infrastructure system 110. It is also understood that the logistics management system 120 is configured to communicate directly with the vehicle 102 as well.

In one or more embodiments, and additionally in consideration of the illustration provided in FIG. 3 that depicts the marshaling environment 300, the logistics management system 120 is configured to facilitate inspecting the one or more vehicles and then marshaling the one or more vehicles to a particular repair bay 304a of one or more repair bays 304a-304c based on any recommended repairs associated with the vehicle 102. It is understood that while FIG. 3 depicts a certain number of parking locations and/or repair bays, the marshaling environment 300 can include any number of parking locations and/or repair bays.

In one or more embodiments, the vehicle 102 is configured to receive one or more inputs from the system operator 106 that can initiate an inspection of the vehicle 102. However, it is understood that the inspection of the vehicle 102 can be initiated absent the receipt of the one or more inputs. For example, the inspection of the vehicle 102 can be automatically initiated based on an indication that the vehicle 102 is at a particular location within the marshaling environment 300 or for any other reason.

In one or more embodiments, the inspection of the vehicle 102 can be performed by the infrastructure system 110, the system operator 106, and/or the vehicle 102 itself. For example, the vehicle 102 can pair an implementation of one or more diagnostic check(s) with a utilization of the plurality of on-board sensors 204 to perform a self-inspection in an instance wherein the vehicle 102 is tasked with inspecting itself (e.g., the vehicle 102). In one or more examples, the inspection of the vehicle 102 can include an inspection of a performance of one or more functionalities associated with an interior of the vehicle 102, an exterior of the vehicle 102, or a combination thereof. In one or more examples, the inspection of the vehicle 102 may result in the vehicle-side AVM algorithm 114, the infrastructure-side AVM algorithm 112, and/or the system operator 106 identifying one or more repairs that should be made to the vehicle 102. In one or more examples, the vehicle-side AVM algorithm 114, the infrastructure-side AVM algorithm 112, and/or the system operator 106 can recommend (e.g., to the vehicle 102) that the one or more identified repairs should be addressed (e.g., repaired). In one or more examples, the vehicle-side AVM algorithm 114, the infrastructure-side AVM algorithm 112, and/or the system operator 106 can recommend one or more subsequent inspections be made to the vehicle 102 based on the one or more identified repairs.

In one or more examples, the infrastructure-side AVM algorithm 112 and/or the vehicle-side AVM algorithm 114 can track the component(s) and/or system(s) that are associated with the recommended repairs. As another example, the component(s) and/or system(s) that are associated with the recommended repairs can be tracked based on one or more inputs related to the inspection of the vehicle 102 that may be received by any of the vehicle-side AVM algorithm 114, the infrastructure-side AVM algorithm 112, and/or the system operator 106.

In one or more embodiments, the vehicle-side AVM algorithm 114 is configured to receive each of the recommendation(s) regarding the one or more identified repairs and/or subsequent inspections and aggregate the one or more identified repairs and/or subsequent inspections by generating (e.g., creating) a service-based list. For example, the service-based list is generated based on the recommendation(s) that the one or more identified repairs and/or subsequent inspections should be addressed. As another example, the service-based list is also generated based on an observation/inspection made by the operator 106, the inspection of the vehicle 102 by the infrastructure system 110, self-identification of one or more issues associated with the vehicle 102, or a combination thereof. In one or more examples, the vehicle-side AVM algorithm 114 is also configured to determine an importance value of each of the one or more recommended repairs and/or subsequent inspections. As another example, the vehicle-side AVM algorithm 114 is further configured to assign a priority to each of the one or more recommended repairs and/or subsequent inspections based on the importance value of each of the one or more recommended repairs and/or subsequent inspections. For example, a high importance value can correspond to a recommended repair and/or subsequent inspection related to a propulsive-feature of the vehicle 102. As another example, a low importance value can correspond to a recommended repair and/or subsequent inspection related to an aesthetic feature of the vehicle 102. However, it is understood that the vehicle-side AVM algorithm 114 can assign the importance value to any of the recommended repairs and/or subsequent inspections based on any consideration related to the functionality of the vehicle 102.

In one or more embodiments, one or more service-based operations related to the one or more recommended repairs and/or subsequent inspections is determined by the vehicle-side AVM algorithm 114. In one or more examples, the one or more service-based operations is determined based on the service-based list. In another example, the one or more service-based operations is determined based on the recommended repairs and/or subsequent inspections.

In one or more embodiments, the vehicle-side AVM algorithm 114 is configured to determine any relevant tools and/or resources that may be necessary to address each of the one or more identified repairs and/or subsequent inspections. In one or more examples, the tools and/or resources can include a vehicle lift, a fluid removal system, a fill system, diagnostic equipment, a component-specific lift, sensor calibration equipment, or a combination thereof. However, it is understood that the tools and/or resources can include any other repair-related tool/resource or any other inspection-related tool/resource. The vehicle-side AVM algorithm 114 is also configured to request one or more specialized personnel (e.g., a technician or the system operator 106) to address, or be involved with, the one or more identified repairs and/or to perform the subsequent inspections.

In one or more embodiments, the vehicle 102 is configured to transmit a service request to the logistics management system 120. In one or more examples, the service request can include information associated with each operation necessary to address the one or more recommended repairs and/or subsequent inspections. In one or more examples, the logistics management system 120 can be configured to manage the one or more repair bays 304a-304c as a central server. However, it is understood that each of the repair bays of the one or more repair bays 304a-304c can have an individual logistics management system disposed therein.

In one or more embodiments, the logistics management system 120 is configured to determine a complexity associated with each operation necessary to address the one or more recommended repairs and/or subsequent inspections. In one or more additional embodiments, the logistics management system 120 is also configured to assign a complexity rating to each operation necessary to address the one or more recommended repairs and/or subsequent inspections based on the determined complexity associated with each operation. In one or more examples, a low complexity rating can correspond to a repair and/or a subsequent inspection that is considered to be minimally invasive and can be performed in a parking lot or other short term storage location within the marshaling environment 300. In one or more examples, a high complexity rating can correspond to a repair and/or a subsequent inspection that is considered to be more invasive than that of the repair and/or the subsequent inspection correspondent to the low complexity rating and may need the vehicle 102 to be marshaled to the one or more repairs bays 304a-304c.

In one or more embodiments, and in an instance wherein the one or more recommended repairs and/or subsequent inspections correspond to the low complexity rating, the logistics management system 120 is configured to assign the vehicle 102 to a particular parking location 306 (e.g., a parking spot or a target location) adjacent the repair bay 304a. However, it is understood that the vehicle 102 can be assigned to any parking location within any proximity from any of the one or more repair bays 304a-304c. As an example, the logistics management system 120 is also configured to transmit one or more instructions to a technician that includes information associated with the one or more recommended repairs and/or subsequent inspections needed to be performed on the vehicle 102. It is understood that the technician can be, but is not limited to, a human technician or a robot technician, for example.

In an instance wherein the vehicle 102 is equipped with automated driving functionality, the infrastructure system 110 will marshal the vehicle 102 to the parking location 306 via automated driving. However, and in an instance wherein the vehicle 102 is either not equipped with automated driving functionality or if the one or more recommended repairs affect the autonomous driving capabilities of the vehicle 102, rendering the vehicle 102 unable to be marshaled to the parking location 306 via automated driving, the technician can operate the vehicle 102 and manually drive the vehicle 102 to the parking location 306. In one or more examples, the technician can operate the vehicle 102 based on one or more directional instructions displayed on a display screen (not shown) of the vehicle 102. As another example, the one or more directional instructions can be received from the infrastructure system 110 and/or the logistics management system 120 that can cause the vehicle 102 to display the one or more directional instructions.

In one or more examples, once the vehicle 102 is positioned in the parking location 306, the logistics management system 120 is configured to assign the vehicle 102 to a position in a service-based queue. In other words, the vehicle 102 is placed in a line of other vehicles waiting for repairs and/or inspections to be performed. However, the logistics management system 120 is also configured to determine a priority of addressing the repairs and/or inspections associated with the vehicle 102 and can assign the vehicle 102 to the position in the service-based queue based on the determination of the priority. For example, the priority can be a type of repair or an expected shipping date (e.g., delivery date) of the vehicle 102. However, it is understood that the priority can be any consideration associated with the delivery, repair, and/or inspection of the vehicle 102.

In one or more embodiments, and in an instance wherein the one or more recommended repairs and/or subsequent inspections correspond to the high complexity rating, the logistics management system 120 is configured to determine which repair bay of the one or more repair bays 304a-404c is equipped to perform the one or more recommended repairs and/or subsequent inspections on the vehicle 102. For example, the logistics management system 120 is configured to make the determination associated with which repair bay is equipped to perform the one or more recommended repairs and/or subsequent inspections based on a comparison of whether the tools and/or resources necessary to address the one or more recommended repairs and/or subsequent inspections as determined by the vehicle-side AVM algorithm 114 matches the tools and/or resources at each repair bay of the one or more repair bays 304a-304c.

In one or more embodiments, each section of each repair bay of the one or more repair bays 304a-304c can be organized so that the logistics management system 120 is aware of a location of each of the tools and/or resources with which each repair bay of the one or more repair bays 304a-304c is equipped. As an example, each section of each repair bay of the one or more repair bays 304a-304c can be organized based on an efficiency-related determination made by the logistics management system 120 so that the tools and/or resources are efficiently provided, which results in minimizing a time the vehicle 102 takes in moving around any of the repair bays of the one or more repair bays 304a-304c. As another example, the efficiency-related determination can be made based on historical data related to how long it takes for the vehicle 102 to move about the one or more repair bays 304a-304c.

In one or more embodiments, the logistics management system 120 is further configured to determine an availability of each section of each repair bay of the one or more repair bays 304a-304c that has been determined to be equipped with the necessary tools and/or resources to address the one or more recommended repairs and/or subsequent inspections associated with the vehicle 102. In one or more examples, the availability can be determined based on whether the section is being used at the time the logistics management system 120 makes the determination regarding the availability of each section of each repair bay of the one or more repair bays 304a-304c. For example, the determination of the availability of each section of each repair bay of the one or more repair bays 304a-304c can be made dynamically (e.g., in real-time) based on the technician tracking a progress of the performance of the one or more recommended repairs and/or subsequent inspections of the vehicle 102 and/or or one or more outputs received from the sensor component 116 of the infrastructure system 110. As another example, the one or more outputs from the sensor component 116 of the infrastructure system 110 can be received by the logistics management system 120 and can be based on one or more captured images of the progress associated with the performance of the one or more recommended repairs and/or subsequent inspections of the vehicle 102.

In one or more embodiments, the logistics management system 120 can determine that different equipment is necessary to address the one or more recommended repairs and/or subsequent inspections associated with the vehicle 102. In one or more examples, and in an instance wherein the logistics management system 120 determines that different equipment is necessary to address the one or more recommended repairs and/or subsequent inspections associated with the vehicle 102 and the vehicle 102 is equipped with automated driving functionality, the infrastructure system 110 will marshal the vehicle 102 to the parking location 306 via automated driving. However, and in an instance wherein the vehicle 102 is either not equipped with automated driving functionality or if the repair(s) affects the autonomous driving capabilities of the vehicle 102, rendering the vehicle 102 unable to be marshaled to the parking location 306 via automated driving, the technician can operate the vehicle 102 and manually drive the vehicle 102 to the parking location 306.

In this case, for example, the parking location 306 is equipped with additional resources necessary to complete the performance of the one or more recommended repairs and/or subsequent inspections of the vehicle 102. However, if the parking location 306 is not equipped with the additional resources, the additional resources can be brought to the parking location 306, either by the technician and/or an automated robot that is marshaled (e.g., by the infrastructure system 110) to the parking location 306. As an example, the additional resources can arrive at the parking location 306 before the vehicle 102 arrives at the parking location 306. As another example, the additional resources can also arrive at the parking location 306 upon request by the vehicle 102, the infrastructure system 110, the logistics management system 120, or a combination thereof. In one or more examples, the logistics management system 120 is configured to determine a parking location of the one or more parking locations that has adequate space to accommodate the instance wherein the additional resources are brought to the parking location 306.

In one or more embodiments, the logistics management system 120 can determine that a technician with a particular skillset is necessary to address the one or more recommended repairs and/or subsequent inspections associated with the vehicle 102. In one or more examples, and in an instance wherein the logistics management system 120 determines that the technician with the particular skillset is necessary to address the one or more recommended repairs and/or subsequent inspections associated with the vehicle 102 and the vehicle 102 is equipped with automated driving functionality, the infrastructure system 110 will marshal the vehicle 102 to the parking location 306 via automated driving. However, and in an instance wherein the vehicle 102 is either not equipped with automated driving functionality or if the repair(s) affects the autonomous driving capabilities of the vehicle 102, rendering the vehicle 102 unable to be marshaled to the parking location 306 via automated driving, the technician can operate the vehicle 102 and manually drive the vehicle 102 to the parking location 306. In this case, for example, the vehicle 102 may be parked at the parking location 306 until the technician with the particular skillset arrives at the repair bay 304a, at which point the vehicle 102 is either marshaled back to the repair bay 304a or driven back to the repair bay 304a by the technician.

In one or more embodiments, and in an instance wherein the logistics management system 120 determines that the repair bay 304a (for example) is not available, the logistics management system 120 will assign the vehicle 102 to a queue. In one or more examples, and in an instance wherein the logistics management system 120 determines that the repair bay 304a is not available, the infrastructure system 110 will marshal the vehicle 102 to the parking location 306 via automated driving. However, and in an instance wherein the vehicle 102 is either not equipped with automated driving functionality or if the repair(s) affects the autonomous driving capabilities of the vehicle 102, rendering the vehicle 102 unable to be marshaled to the parking location 306 via automated driving, the technician can operate the vehicle 102 and manually drive the vehicle 102 to the parking location 306. In this case, for example, the vehicle 102 will remain in the queue until the repair bay 304a becomes available, at which point the vehicle 102 is either marshaled back to the repair bay 304a or driven back to the repair bay 304a by the technician.

In one or more embodiments, the logistics management system 120 is configured to communicate with the one or more repair bays 304a-304c so that, for example, one or more repair bay lifts can be monitored. In an example, the monitoring of the one or more repair bay lifts can ensure proper positioning of lift arms associated with each of the one or more repair bay lifts. In one or more embodiments, the sensor component 116 of the infrastructure system 110 can sense entry of the vehicle 102 within a threshold distance from the lift arms associated with each of the one or more repair bay lifts, at which point the logistics management system 120 can cause the lift arms associated with each of the one or more repair bay lifts to adjust to a position to accommodate the vehicle 102 and ensure the vehicle 102 is centered on the repair bay lift before the repair bay lift is able to function. For example, the logistics management system 120 can cause the lift arms associated with each of the one or more repair bay lifts to adjust to a position to accommodate the vehicle 102 based on the infrastructure system 110 communicating one or more captured images from the sensor component 116 to the logistics management system 120.

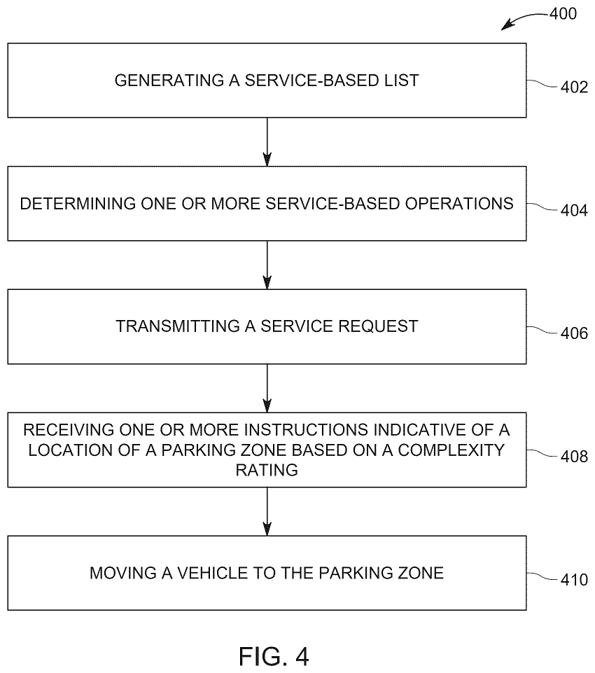

FIG. 4 is a flowchart illustrating an example method 400 for performing one or more inspections and/or repairs on a vehicle (e.g., the vehicle 102). At operation 402, a service-based list associated with the vehicle is generated. As an example, the generation of the service-based list is based on an observation made by an operator (e.g., the system operator 106), an inspection of the vehicle by an infrastructure system (e.g., the infrastructure system 110), self-identification of one or more issues associated with the vehicle, or a combination thereof. As another example, the service-based list is generated by the vehicle.

At operation 404, one or more service-based operations is determined. For example, the one or more service-based operations is determined based on the service-based list. At operation 406, a service request is transmitted to a management system (e.g., the logistics management system 120). As an example, the service request includes information associated with each operation of the one or more service-based operations. As another example, the information associated with each operation of the one or more service-based operations relates to one or more tools, one or more resources, or a combination thereof. As yet another example, the one or more tools and the one or more resources includes a vehicle lift, a fluid removal system, a fill system, diagnostic equipment, a component-specific lift, sensor calibration equipment, or a combination thereof.

At operation 408, one or more instructions indicative of a location of a parking zone is received from the management system. As an example, the receipt of the one or more instructions indicative of the location of the parking zone is based on a complexity rating associated with each operation of the one or more service-based operations. As another example, the one or more instructions directs the vehicle to a short-term storage location (e.g., the parking location 306) of the parking zone based on a low complexity rating associated with the service request. As yet another example, the one or more instructions directs the vehicle to a location of the parking zone proximate a workstation (e.g., the repair bay 304a) equipped to perform a service based on a high complexity rating associated with the service request and the one or more service-based operations.

At operation 410, the vehicle moves to the parking zone. As an example, the vehicle moves to the parking zone in response to receiving the one or more instructions. In one or more embodiments, the service-based list includes one or more service-based tasks. As an example, the one or more service-based tasks is prioritized based on an association of each task of the one or more service-based tasks with a functionality of one or more components of the vehicle.

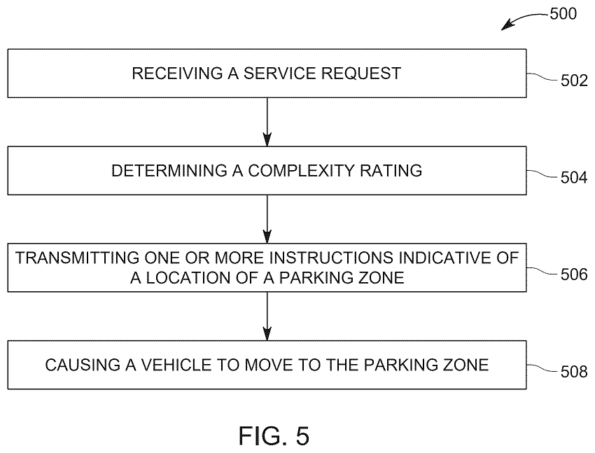

FIG. 5 is a flowchart illustrating another example method 500 for performing one or more inspections and/or repairs on a vehicle (e.g., the vehicle 102). At operation 502, a service request is received from the vehicle. For example, the service request includes information associated with each operation of one or more service-based operations. As another example, the information relates to one or more tools, one or more resources, or a combination thereof. As yet another example, the service-based list is received at an infrastructure system (e.g., the infrastructure system 110).

At operation 504, a complexity rating associated with each operation of the one or more service-based operations is determined. At operation 506, one or more instructions indicative of a location of a parking zone is transmitted to the vehicle. For example, the transmission of the one or more instructions is based on the determination of the complexity rating associated with each operation of the one or more service-based operations. As an example, the one or more instructions directs the vehicle to a short-term storage location (e.g., the parking location 306) of the parking zone based on a low complexity rating associated with the service request. As yet another example, the one or more instructions directs the vehicle to a location of the parking zone proximate a workstation (e.g., the repair bay 304a) equipped to perform a service based on a high complexity rating associated with the service request and the one or more service-based operations.

At operation 508, the infrastructure system causes the vehicle to move to the parking zone. In one or more embodiments the service-based list includes one or more service-based tasks. As an example, the one or more service-based tasks is prioritized based on an association of each task of the one or more service-based tasks with a functionality of one or more components of the vehicle. As another example, the one or more service-based operations is based on the service-based list. In one or more embodiments, a determination is made regarding whether the workstation is equipped to perform the service based on an availability of the workstation and/or whether the one or more tools and the one or more resources matches one or more tools of the workstation and one or more resources of the workstation. In one or more embodiments, the vehicle is assigned a position in a service-based queue based on the complexity rating.

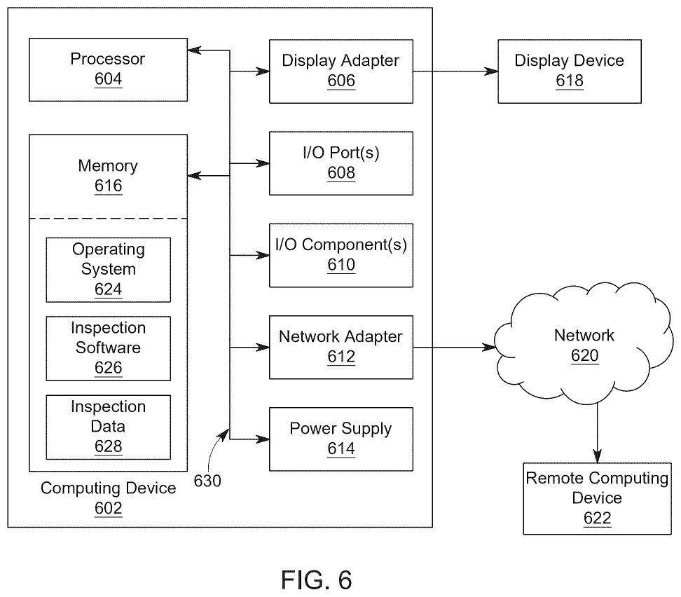

FIG. 6 illustrates an operating environment, such as a computer system, that facilitates the performance of the one or more systems and methods described herein. More specifically, the systems and methods described herein can be implemented using a computing device 602. For example, the computing device 602 can be a personal computer, a desktop, a laptop, a tablet, a hand-held computer, a server, a workstation, a mainframe, a wearable computer, a supercomputer, or a combination thereof. However, it is understood that the aforementioned examples of the computing device 602 is non-exhaustive and the computing device 602 can be any type of processing or computing device. The computing device 602 generally includes a processor 604, a display adapter 606, one or more input/output port(s) 608, one or more input/output component(s) 610, a network adapter 612, a power supply 614, and a memory 616. However, it is understood that the computing device 602 can include any additional components therein and is not required to include any of the listed components (e.g., the processor 604, the display adapter 606, the one or more input/output port(s) 608, the one or more input/output component(s) 610, the network adapter 612, the power supply 614, and the memory 616).

The processor 604 is configured to provide instructions to the computing device 602 so that the computing device 602 can process one or more tasks including the implementation of a software program to perform one or more operations as described in more detail herein. It is also understood that the computing device 602 may include any number or processors 604 therein. The display adapter 606 can be a graphics card or a video board that provides the computing device 602 with a capability to display content on a display device 618. For example, the display device 618 can be any screen, monitor, and/or light-emitting component associated with any of the personal computer, the desktop, the laptop, the tablet, the hand-held computer, the server, the workstation, the mainframe, the wearable computer, the supercomputer, or a combination thereof. However, it is understood that the aforementioned examples of the display device 618 is non-exhaustive and that the display device 618 can be any type of device capable of providing a visual display.

The input/output port(s) 608 provide a number of interfaces (e.g., sockets) for one or more cables to connect to the computing device 602. It is understood that there may be any number of input/output port(s) 608 on the computing device 602. For example, the input/output port(s) 608 provides a means for the computing device 602 to receive signals and/or data from an external device connected to the computing device 602 via the one or more cables. As another example, the input/output port(s) 608 provide a means for the computing device 602 to send signals and/or data to an external device connected to the computing device 602 via the one or more cables. The input/output component(s) 610 can include one or more components that support the input/output port(s) 608 such as, but not limited to, a switch, a push button, a pressure mat, a float switch, a keypad, a radio receive, or a combination thereof.

The network adapter 612 can be any type of network interface controller that is configured to provide a means for communicating over a network 620 with another computing device, such as a remote computing device 622. For example, the remote computing device 622 can be a user device such as a cellular-phone, a smartphone, a tablet, a laptop, or a combination thereof. The power supply 614 is configured to convert alternating high voltage current (e.g., AC) into direct current (e.g., DC) to provide power to the other components (e.g., the processor 604, the display adapter 606, the one or more input/output port(s) 608, the one or more input/output component(s) 610, the network adapter 612, and the memory 616) of the computing device 602.

Additionally, the memory 616 can be a mass storage device and/or a system memory such as a hard disk drive, a memory card, a solid-state drive, random access memory (RAM), or a combination thereof. The memory 616 is configured to provide storage for instructions and data associated with the operation of the computing device 602. The memory 616 can generally include an operating system 624, inspection software 626, and inspection data 628. For example, the operating system 624 is configured to manage and/or process any of the data and/or instructions associated with the inspection software 626 and/or inspection data 628, as described in more detail herein.

Furthermore, a system bus 630 is also included within the computing device 602 that is configured to couple each of the various components (e.g., the processor 604, the display adapter 606, the one or more input/output port(s) 608, the one or more input/output component(s) 610, the network adapter 612, the power supply 614, and the memory 616) of the computing device 602. It is also understood that each of the components of the computing device 602, and the functionality associated with each of the components of the computing device 602, may be implemented within the remote computing device 622. While the operating environment illustrated within FIG. 6 depicts a particular configuration associated with at least the computing device 602, the network 620, and the remote computing device 622, it is understood that the operating environment may be configured in any way.

Thus, one or more examples of the present disclosure provides a means for providing an automated method for inspecting and repairing a vehicle based on at least an initiation of a self-inspection performed by the vehicle. The present disclosure also provides a complexity rating (e.g., from a management system) of the necessary repairs as indicated by the vehicle and facilitation of the repairs and/or subsequent inspections associated with the vehicle.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.” In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

1. A method comprising:
generating a service-based list associated with a vehicle;
determining one or more service-based operations based on the service-based list;
transmitting, to a management system, a service request that includes information associated with each operation of the one or more service-based operations;
receiving, from the management system, one or more instructions indicative of a location of a parking zone based on a complexity rating associated with each operation of the one or more service-based operations; and
moving the vehicle to the location in the parking zone based on the complexity rating in response to receiving the one or more instructions, wherein one or more locations within the parking zone are associated with a complexity rating that is different than a complexity rating associated with one or more other locations within the parking zone.

2. The method of claim 1, wherein the generation of the service-based list is based on an observation made by an operator, an inspection of the vehicle by an infrastructure system, self-identification of one or more issues associated with the vehicle, or a combination thereof.

3. The method of claim 1, further comprising:
prioritizing one or more service-based tasks included as part of the service-based list based on an association of each task of the one or more service-based tasks with a functionality of one or more components of the vehicle.

4. The method of claim 1, wherein the information associated with each operation of the one or more service-based operations relates to one or more tools, one or more resources, or a combination thereof, and wherein a high complexity rating is associated with a high importance value corresponding to a recommended repair or subsequent inspection related to a propulsive-feature of the vehicle and a low complexity rating is associated with a low importance value corresponding to a recommended repair or subsequent inspection related to an aesthetic feature of the vehicle.

5. The method of claim 4, wherein the one or more tools and the one or more resources includes a vehicle lift, a fluid removal system, a fill system, diagnostic equipment, a component-specific lift, sensor calibration equipment, or a combination thereof.

6. The method of claim 1, wherein the one or more instructions directs the vehicle to a short-term storage location of the parking zone based on a low complexity rating associated with the service request.

7. The method of claim 1, wherein the one or more instructions directs the vehicle to a location of the parking zone proximate a workstation equipped to perform a service based on a high complexity rating associated with the service request and the one or more service-based operations.

8. A method comprising:
receiving, from a vehicle, a service request that includes information associated with each operation of one or more service-based operations, wherein the information relates to one or more tools, one or more resources, or a combination thereof;
determining a complexity rating associated with each operation of the one or more service-based operations;
transmitting, to the vehicle, one or more instructions indicative of a location of a parking zone based on the determination of the complexity rating associated with each operation of the one or more service-based operations; and
causing the vehicle to move to the location in the parking zone based on the complexity rating, wherein one or more locations within the parking zone are associated with a complexity rating that is different than a complexity rating associated with one or more other locations within the parking zone.

9. The method of claim 8, wherein one or more service-based tasks included as part of a service-based list is prioritized based on an association of each task of the one or more service-based tasks with a functionality of one or more components of the vehicle, and wherein the one or more service-based operations is based on the service-based list.

10. The method of claim 8, wherein the one or more instructions directs the vehicle to a short-term storage location of the parking zone based on a low complexity rating associated with the service request.

11. The method of claim 8, wherein the one or more instructions directs the vehicle to a location of the parking zone proximate a workstation equipped to perform a service based on a high complexity rating associated with the service request and the one or more service-based operations.

12. The method of claim 11, further comprising:
determining that the workstation is equipped to perform the service based on an availability of the workstation and whether the one or more tools and the one or more resources matches one or more tools of the workstation and one or more resources of the workstation.

13. The method of claim 8, further comprising:
assigning the vehicle a position in a service-based queue based on the complexity rating.

14. A system comprising:
a management system configured to:
receive, from a vehicle, a service request that includes information associated with each operation of one or more service-based operations, wherein the information relates to one or more tools, one or more resources, or a combination thereof,
determine a complexity rating associated with each operation of the one or more service-based operations, and
transmit, to the vehicle, one or more instructions indicative of a location of a parking zone based on the determination of the complexity rating associated with each operation of the one or more service-based operations, wherein one or more locations within the parking zone are associated with a complexity rating that is different than a complexity rating associated with one or more other locations within the parking zone; and
the vehicle configured to:
generate a service-based list associated with the vehicle,
determine one or more service-based operations based on the service-based list,
transmit, to the management system, the service request, and
receive the one or more instructions, wherein in response to receiving the one or more instructions the vehicle and move to the location in the parking zone based on the complexity rating.

15. The system of claim 14, wherein the generation of the service-based list is based on an observation made by an operator, an inspection of the vehicle by an infrastructure system, self-identification of one or more issues associated with the vehicle, or a combination thereof.

16. The system of claim 14, wherein the vehicle is further configured to:
prioritize one or more service-based tasks included as part of the service-based list based on an association of each task with the one or more service-based tasks to a functionality of one or more components of the vehicle.

17. The system of claim 14, wherein the one or more instructions directs the vehicle to a short-term storage location of the parking zone based on a low complexity rating associated with the service request.

18. The system of claim 14, wherein the one or more instructions directs the vehicle to a location of the parking zone proximate a workstation equipped to perform a service based on a high complexity rating associated with the service request and the one or more service-based operations.

19. The system of claim 18, wherein the management system is further configured to:
determine that the workstation is equipped to perform the service based on an availability of the workstation and whether the one or more tools and the one or more resources matches one or more tools of the workstation and one or more resources of the workstation.

20. The system of claim 14, wherein the management system is further configured to:
assign the vehicle a position in a service-based queue based on the complexity rating.
